(19) United States
(12) Patent Application Publication
(10) Pub. No.: US 2004/0117607 A1
(43) Pub. Date: Jun. 17, 2004

(54) Apparatus and method for separating detection and assertion of a trigger event

(76) Inventor: Gary L. Swoboda, Sugar Land, TX (US)

Correspondence Address: TEXAS INSTRUMENTS INCORPORATED, P O BOX 655474, M/S 3999, DALLAS, TX, 75265

(21) Appl. No.: 10/729,212

(22) Filed: Dec. 5, 2003

Related U.S. Application Data
(60) Provisional application No. 60/434,077, filed on Dec. 17, 2002.

(51) Int. Cl. G06F 9/24

(52) U.S. Cl. 713/1

(57) ABSTRACT

A trace test and debug system for a target processor includes a trigger unit or other apparatus that permits the detection of selected events. The trigger unit also receives input signals concerning the operational mode of the target processor. The trigger unit is responsive to programmed input by a user. As a consequence, the trigger unit can separate the detection of an event from the response to the event. In the specific example of the trigger unit, the generated trigger signals can be separated from the actual detection of the event. This capability is particularly useful when the user desires that the assertion of the response to an event occurring during foreground (interrupt service routine) not be permitted during the foreground code execution. The assertions of the response to an event are therefore delayed until the target processor is in a background (normal program) mode of operation. Thus, the response to an event can be separated from the detection of the event under the control of the user.

This application claims priority under 35 USC §119(e)(1) of Provisional Application No. 60/434,077 (TI-34655P) filed Dec. 17, 2002.

### RELATED APPLICATIONS

U.S. patent application (Attorney Docket No. TI-34654), entitled APPARATUS AND METHOD FOR SYNCHRONIZATION OF TRACE STREAMS FROM MULTIPLE PROCESSORS, invented by Gary L. Swoboda, filed on even date herewith, and assigned to the assignee of the present application; U.S. patent application (Attorney Docket No. TI-34656), entitled APPARATUS AND METHOD FOR STATE SELECTABLE TRACE STREAM GENERATION, invented by Gary L. Swoboda, filed on even date herewith, and assigned to the assignee of the present application; U.S. patent application (Attorney Docket No. TI-34657), entitled APPARATUS AND METHOD FOR SELECTING PROGRAM HALTS IN AN UNPROTECTED PIPELINE AT NON-INTERRUPTIBLE POINTS IN CODE EXECUTION, invented by Gary L. Swoboda and Krishna Allam, filed on even date herewith, and assigned to the assignee of the present application; U.S. patent application (Attorney Docket No. TI-34658), entitled APPARATUS AND METHOD FOR REPORTING PROGRAM HALTS IN AN UNPROTECTED PIPELINE AT NON-INTERRUPTIBLE POINTS IN CODE EXECUTION, invented by Gary L. Swoboda, filed on even date herewith, and assigned to the assignee of the present application; U.S. patent application (Attorney Docket No. TI-34659), entitled APPARATUS AND METHOD FOR A FLUSH PROCEDURE IN AN INTERRUPTED TRACE STREAM, invented by Gary L. Swoboda, filed on even date herewith, and assigned to the assignee of the present application; U.S. patent application (Attorney Docket No. TI-34660), entitled APPARATUS AND METHOD FOR CAPTURING AN EVENT OR COMBINATION OF EVENTS RESULTING IN A TRIGGER SIGNAL IN A TARGET PROCESSOR, invented by Gary L. Swoboda, filed on even date herewith, and assigned to the assignee of the present application; U.S. patent application (Attorney Docket No. TI-34661), entitled APPARATUS AND METHOD FOR CAPTURING THE PROGRAM COUNTER ADDRESS ASSOCIATED WITH A TRIGGER SIGNAL IN A TARGET PROCESSOR, invented by Gary L. Swoboda, filed on even date herewith, and assigned to the assignee of the present application; U.S. patent application (Attorney Docket No. TI-34662), entitled APPARATUS AND METHOD DETECTING ADDRESS CHARACTERISTICS FOR USE WITH A TRIGGER GENERATION UNIT IN A TARGET PROCESSOR, invented by Gary Swoboda and Jason L. Peck, filed on even date herewith, and assigned to the assignee of the present application; U.S. patent application (Attorney Docket No. TI-34663), entitled APPARATUS AND METHOD FOR TRACE STREAM IDENTIFICATION OF A PROCESSOR RESET, invented by Gary L. Swoboda, Bryan Thome and Manisha Agarwala, filed on even date herewith, and assigned to the assignee of the present application; U.S. patent (Attorney Docket No. TI-34664), entitled APPARATUS AND METHOD FOR TRACE STREAM IDENTIFICATION OF A PROCESSOR DEBUG HALT SIGNAL, invented by Gary L. Swoboda, Bryan Thome, Lewis Nardini and Manisha Agarwala, filed on even date herewith, and assigned to the assignee of the present application; U.S. patent application (Attorney Docket No. TI-34665), entitled APPARATUS AND METHOD FOR TRACE STREAM IDENTIFICATION OF A PIPELINE FLATTENER PRIMARY CODE FLUSH FOLLOWING INITIATION OF AN INTERRUPT SERVICE ROUTINE; invented by Gary L. Swoboda, Bryan Thome and Manisha Agarwala, filed on even date herewith, and assigned to the assignee of the present application; U.S. patent application (Attorney Docket No. TI-34666), entitled APPARATUS AND METHOD FOR TRACE STREAM IDENTIFICATION OF A PIPELINE FLATTENER SECONDARY CODE FLUSH FOLLOWING A RETURN TO PRIMARY CODE EXECUTION, invented by Gary L. Swoboda, Bryan Thome and Manisha Agarwala filed on even date herewith, and assigned to the assignee of the present application; U.S. patent application (Docket No. TI-34667), entitled APPARATUS AND METHOD IDENTIFICATION OF A PRIMARY CODE START SYNC POINT FOLLOWING A RETURN TO PRIMARY CODE EXECUTION, invented by Gary L. Swoboda, Bryan Thome and Manisha Agarwala, filed on even date herewith, and assigned to the assignee of the present application; U.S. patent application (Attorney Docket No. TI-34668), entitled APPARATUS AND METHOD FOR IDENTIFICATION OF A NEW SECONDARY CODE START POINT FOLLOWING A RETURN FROM A SECONDARY CODE EXECUTION, invented by Gary L. Swoboda, Bryan Thome and Manisha Agarwala, filed on even date herewith, and assigned to the assignee of the present application; U.S. patent application (Attorney Docket No. TI-34669), entitled APPARATUS AND METHOD FOR TRACE STREAM IDENTIFICATION OF A PAUSE POINT IN A CODE EXECTION SEQUENCE, invented by Gary L. Swoboda, Bryan Thome and Manisha Agarwala, filed on even date herewith, and assigned to the assignee of the present application; U.S. patent application (Attorney Docket No. TI-34670), entitled APPARATUS AND METHOD FOR COMPRESSION OF A TIMING TRACE STREAM, invented by Gary L. Swoboda and Bryan Thome, filed on even date herewith, and assigned to the assignee of the present application; U.S. patent application (Attorney Docket No. TI-34671), entitled APPARATUS AND METHOD FOR TRACE STREAM IDENTIFCATION OF MULTIPLE TARGET PROCESSOR EVENTS, invented by Gary L. Swoboda and Bryan Thome, filed on even date herewith, and assigned to the assignee of the present application; and U.S. patent application (Attorney Docket No. TI-34672 entitled APPARATUS AND METHOD FOR OP CODE EXTENSION IN PACKET GROUPS TRANSMITTED IN TRACE STREAMS, invented by Gary L. Swoboda and Bryan Thome, filed on even date herewith, and assigned to the assignee of the present application are related applications.

### BACKGROUND OF THE INVENTION

1. Field of the Invention

This invention relates generally to the testing of digital signal processing units and, more particularly, to the inclusion in the trace data streams of signals identifying selected events in the digital signal processors under test.

2. Description of Related Art

As microprocessors and digital signal processors have become increasingly complex, advanced techniques have been developed to test these devices. Dedicated apparatus is available to implement the advanced techniques. Referring to FIG. 1A, a general configuration for the test and debug of a target processor is shown. The test and debug procedures operate under control of a host processing unit 10. The host processing unit 10 applies control signals to the emulation unit 11 and receives (test) data signals from the emulation unit 11 by cable connector 14. The emulation unit 11 applies control signals to and receives (test) signals from the target processing unit 12 by connector cable 15. The emulation unit 11 can be thought of as an interface unit between the host processing unit 10 and the target processor 12. The emulation unit 11 must process the control signals from the host processor unit 10 and apply these signals to the target processor 12 in such a manner that the target processor will respond with the appropriate test signals. The test signals from the target processor 12 can be a variety types. Two of the most popular test signal types are the JTAG (Joint Test Action Group) signals and trace signals. The JTAG signal provides a standardized test procedure in wide use. Trace signals are signals from a multiplicity of junctions in the target processor 12. While the width of the bus interfacing to the host processing unit 10 generally have a standardized width, the bus between the emulation unit 11 and the target processor 12 can be increased to accommodate the increasing complexity of the target processing unit 12. Thus, part of the interface function between the host processing unit 10 and the target processor 12 is to store the test signals until the signals can be transmitted to the host processing unit 10.

Referring to FIG. 1B, the operation of the trigger generation unit 19 is shown. The trigger unit provides the main component by which the operation/state of the target processor can be altered. At least one event signal is applied to the trigger generation unit 19. Based on the identity of the event signal(s) applied to the trigger generation unit 19, a trigger signal is selected. Certain events and combination of events, referred to as an event front, generate a selected trigger signal that results in certain activity in the target processor such as a debug halt. Combinations of different events generating trigger signals are referred to as jobs. Multiple jobs can have the same trigger signal or combination of trigger signals. In the test and debug of the target processor, the trigger signals can provide impetus for changing state in the target processor or for performing a specified activity. The event front defines the reason for the generation of trigger signal. This information is important in understanding the operation of the target processor because, as pointed out above, several combinations of events can result in the generation of a trigger signal. In order to analyze the operation of the target processing unit, the portion of the code resulting in the trigger signal must be identified. However, the events in the host processor leading to the generation of event signals can be complicated. Specifically, the characteristics of an instruction at a program counter address can determine whether a trigger signal should be generated. A trigger signal can be an indication of when an address is within a range of addresses, outside of a range of addresses, some combination of address characteristics, and/or the address is aligned with a reference address. In this instance, the address can be the program address of an instruction or a memory address directly or indirectly referenced by a program instruction.

The operation of the target processor involves three states. In the normal code execution state, the execution of normal and interrupt service routines proceed as if there is no test and debug. In secondary code execution, the code is related to a real-time interrupt after a debug event has halted code execution. The central processor code execution is designated as real-time, allowing the service of interrupt designated as real-time after the code execution is halted. The third state involves not running code. No code execution occurs when the emulation functions are enabled, a debug event halts code execution, and no real-time interrupt is being serviced after the code execution is halted. A developer may wish to separate the detection of an event from the assertion event signal associated with the event. For example, a developer may wish not to interrupt secondary (interrupt service routine) code execution for respond to an event. The generation of the event signal (or assertion) can be generated for example during the primary code execution.

A need has been felt for apparatus and an associated method having the feature that the assertion of a detected event can be controlled by user input. It would be a further feature of the apparatus and associated method that the detected event identified by the test and debug apparatus of the target processing unit during first state of target processor can provide a trigger signal response during second state of the processing unit. It is still another feature of the present invention to assert a trigger signal during primary code execution in response to an event identified during the previous secondary code execution,

### SUMMARY OF THE INVENTION

The aforementioned and other features are accomplished, according to the present invention, by providing the target processor with trigger unit that generates event signals in response to central processing unit and user input signals. The trigger unit can be programmed to identify an event signal, but the trigger unit does not immediately issue an appropriate trigger signal. When the target processing unit receives target processor input signals indicating that an appropriate processor state has been reached, the trigger unit issues the resulting trigger signal(s) initiating an appropriate response in the target processing unit.

Other features and advantages of present invention will be more clearly understood upon reading of the following description and the accompanying drawings and the claims.

### BRIEF DESCRIPTION OF THE DRAWINGS

FIG. 1A is a general block diagram of a system configuration for test and debug of a target processor, while FIG. 1B illustrates a trigger unit in the target processor.

FIG. 2 is a block diagram of selected components in the target processor used the testing of the central processing unit of the target processor according to the present invention.

FIG. 3 is a block diagram of selected components of the illustrating the relationship between the components transmitting trace streams in the target processor.

FIG. 4A illustrates format by which the timing packets are assembled according to the present invention, while FIG. 4B illustrates the incorporation of a periodic sync ID marker in the trace timing stream.

FIG. 5 illustrates the parameters for sync markers in the program counter stream packets according to the present invention.

FIG. 6A illustrates the sync markers in the program counter trace stream when a periodic sync point ID is generated, while FIG. 6B illustrates the reconstruction of the target processor operation from the trace streams according to the present invention.

FIG. 7 is a block diagram illustrating the apparatus used in reconstructing the processor operation from the trace streams according to the present invention.

FIG. 8A illustrates the effect of prohibiting an assertion of the consequences of an event signal during foreground (interrupt service routine) code execution, while FIG. 8B illustrates the effect of permitting the assertion of the consequences of an event signal during foreground (interrupt service routine) code execution.

### DESCRIPTION OF THE PREFERRED EMBODIMENT

1. Detailed Description of the Figures

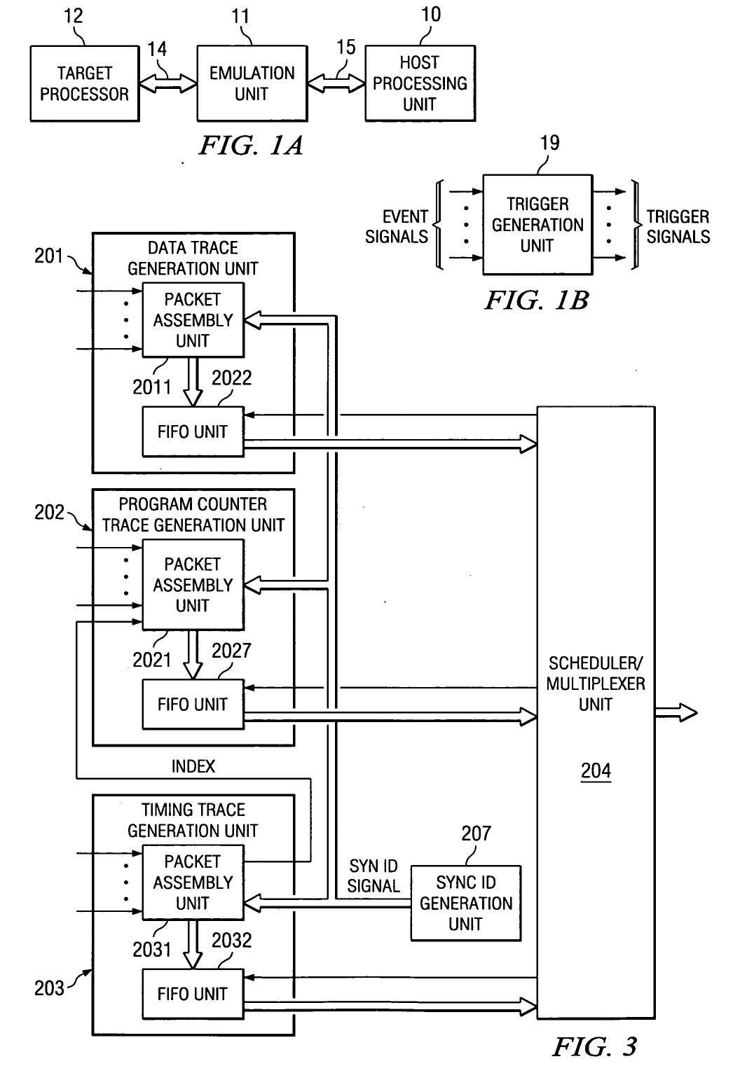

FIG. 1A and FIG. 1B have been described with respect to the related art.

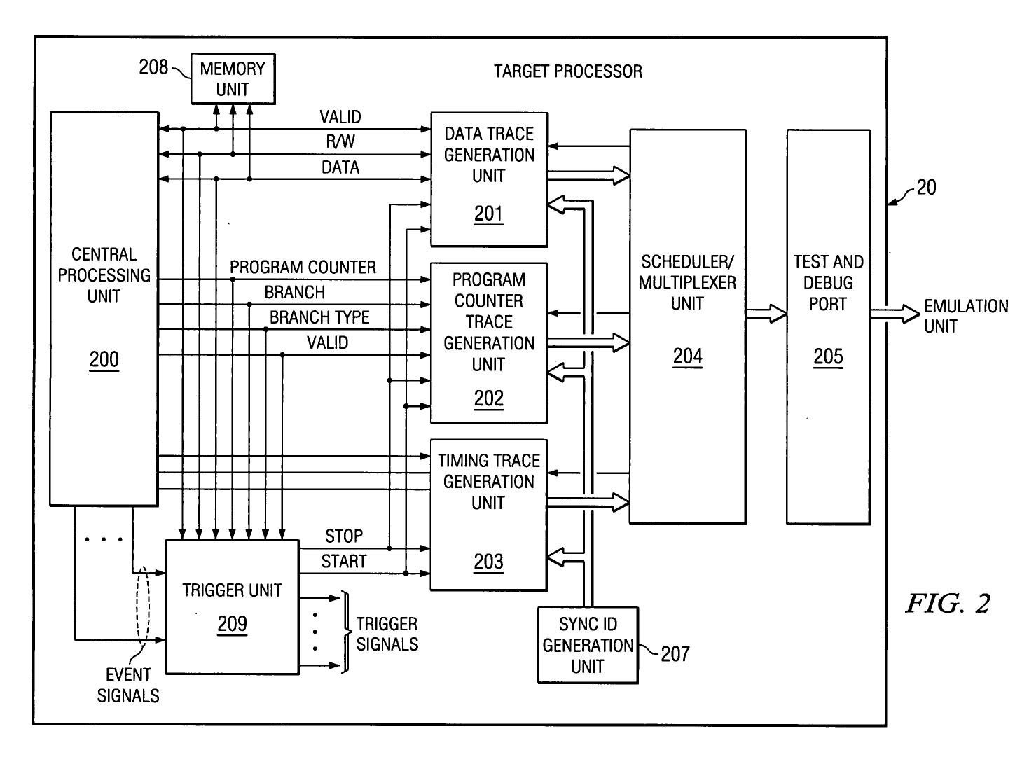

Referring to FIG. 2, a block diagram of selected components of a target processor 20, according to the present invention, is shown. The target processor includes at least one central processing unit 200 and a memory unit 208. The central processing unit 200 and the memory unit 208 are the components being tested. The trace system for testing the central processing unit 200 and the memory unit 202 includes three packet generating units, a data packet generation unit 201, a program counter packet generation unit 202 and a timing packet generation unit 203. The data packet generation unit 201 receives VALID signals, READ/WRITE signals and DATA signals from the central processing unit 200. After placing the signals in packets, the packets are applied to the scheduler/multiplexer unit 204 and forwarded to the test and debug port 205 for transfer to the emulation unit 11. The program counter packet generation unit 202 receives PROGRAM COUNTER signals, VALID signals, BRANCH signals, and BRANCH TYPE signals from the central processing unit 200 and, after forming these signal into packets, applies the resulting program counter packets to the scheduler/multiplexer 204 for transfer to the test and debug port 205. The timing packet generation unit 203 receives ADVANCE signals, VALID signals and CLOCK signals from the central processing unit 200 and, after forming these signal into packets, applies the resulting packets to the scheduler/multiplexer unit 204 and the scheduler/multiplexer 204 applies the packets to the test and debug port 205. Trigger unit 209 receives EVENT signals from the central processing unit 200 and signals that are applied to the data trace generation unit 201, the program counter trace generation unit 202, and the timing trace generation unit 203. The trigger unit 209 applies TRIGGER and CONTROL signals to the central processing unit 200 and applies CONTROL (i.e., STOP and START) signals to the data trace generation unit 201, the program counter generation unit 202, and the timing trace generation unit 203. The sync ID generation unit 207 applies signals to the data trace generation unit 201, the program counter trace generation unit 202 and the timing trace generation unit 203. While the test and debug apparatus components are shown as being separate from the central processing unit 201, it will be clear that an implementation these components can be integrated with the components of the central processing unit 201.

Referring to FIG. 3, the relationship between selected components in the target processor 20 is illustrated. The data trace generation unit 201 includes a packet assembly unit 2011 and a FIFO (first in/first out) storage unit 2012, the program counter trace generation unit 202 includes a packet assembly unit 2021 and a FIFO storage unit 2022, and the timing trace generation unit 203 includes a packet generation unit 2031 and a FIFO storage unit 2032. As the signals are applied to the packet generators 201, 202, and 203, the signals are assembled into packets of information. The packets in the preferred embodiment are 10 bits in width. Packets are assembled in the packet assembly units in response to input signals and transferred to the associated FIFO unit. The scheduler/multiplexer 204 generates a signal to a selected trace generation unit and the contents of the associated FIFO storage unit are transferred to the scheduler/multiplexer 204 for transfer to the emulation unit. Also illustrated in FIG. 3 is the sync ID generation unit 207. The sync ID generation unit 207 applies an SYNC ID signal to the packet assembly unit of each trace generation unit. The periodic signal, a counter signal in the preferred embodiment, is included in a current packet and transferred to the associated FIFO unit. The packet resulting from the SYNC ID signal in each trace is transferred to the emulation unit and then to the host processing unit. In the host processing unit, the same count in each trace stream indicates that the point at which the trace streams are synchronized. In addition, the packet assembly unit 2031 of the timing trace generation unit 203 applies and INDEX signal to the packet assembly unit 2021 of the program counter trace generation unit 202. The function of the INDEX signal will be described below.

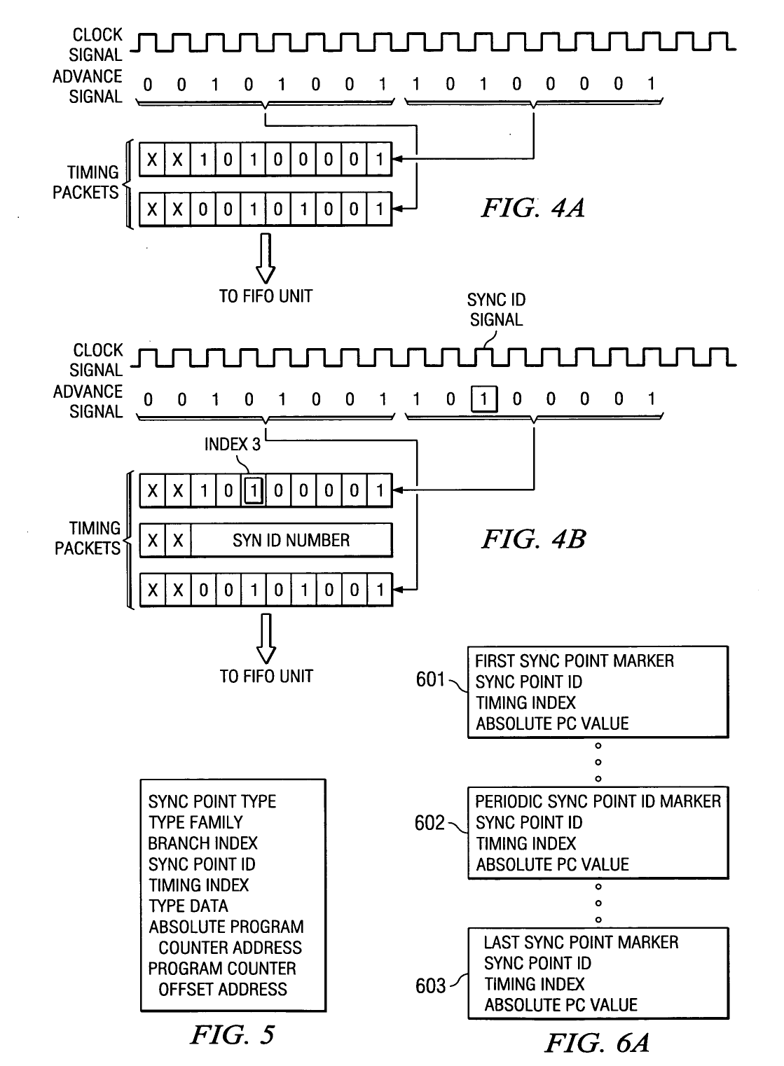

Referring to FIG. 4A, the assembly of timing packets is illustrated. The signals applied to the timing trace generation unit 203 are the CLOCK signals and the ADVANCE signals. The CLOCK signals are system clock signals to which the operation of the central processing unit 200 is synchronized. The ADVANCE signals indicate an activity such as a pipeline advance or program counter advance (( )) or a pipeline non-advance or program counter non-advance (1). An ADVANCE or NON-ADVANCE signal occurs each clock cycle. The timing packet is assembled so that the logic signal indicating ADVANCE or NON-ADVANCE is transmitted at the position of the concurrent CLOCK signal. These combined CLOCK/ADVANCE signals are divided into groups of 8 signals, assembled with two control bits in the packet assembly unit 2031, and transferred to the FIFO storage unit 2032.

Referring to FIG. 4B, the trace stream generated by the timing trace generation unit 203 is illustrated. The first (in time) trace packet is generated as before. During the assembly of the second trace packet, a SYYN ID signal is generated during the third clock cycle. In response, the timing packet assembly unit 2031 assembles a packet in response to the SYNC ID signal that includes the sync ID number. The next timing packet is only partially assembled at the time of the SYNC ID signal. In fact, the SYNC ID signal occurs during the third clock cycle of the formation of this timing packet. The timing packet assembly unit 2031 generates a TIMING INDEX 3 signal (for the third packet clock cycle at which the SYNC ID signal occurs) and transmits this TIMING INDEX 3 signal to the program counter packet assembly unit 2031.

Referring to FIG. 5, the parameters of a sync marker in the program counter trace stream, according to the present invention is shown. The program counter stream sync markers each have a plurality of packets associated therewith. The packets of each sync marker can transmit a plurality of parameters. A SYNC POINT TYPE parameter defines the event described by the contents of the accompanying packets. A program counter TYPE FAMILY parameter provides a context for the SYNC POINT TYPE parameter and is described by the first two most significant bits of a second header packet. A BRANCH INDEX parameter in all but the final SYNC POINT points to a bit within the next relative branch packet following the SYNC POINT. When the program counter trace stream is disabled, this index points a bit in the previous relative branch packet when the BRANCH INDEX parameter is not a logic “0”. In this situation, the branch register will not be complete and will be considered as flushed. When the BRANCH INDEX is a logic “0”, this value point to the least significant value of branch register and is the oldest branch in the packet. A SYNC ID parameter matches the SYNC POINT with the corresponding TIMING and/or DATA SYNC POINT which are tagged with the same SYNC ID parameter. A TIMING INDEX parameter is applied relative to a corresponding TIMING SYNC POINT. For all but LAST POINT SYNC events, the first timing packet after the TIMING PACKET contains timing bits during which the SYNC POINT occurred. When the timing stream is disabled, the TIMING INDEX points to a bit in the timing packet just previous to the TIMING SYNC POINT packet when the TIMING INDEX value is nor zero. In this situation, the timing packet is considered as flushed. A TYPE DATA parameter is defined by each SYNC TYPE. An ABSOLUTE PC VALUE is the program counter address at which the program counter trace stream and the timing information are aligned. An OFFSET COUNT parameter is the program counter offset counter at which the program counter and the timing information are aligned.

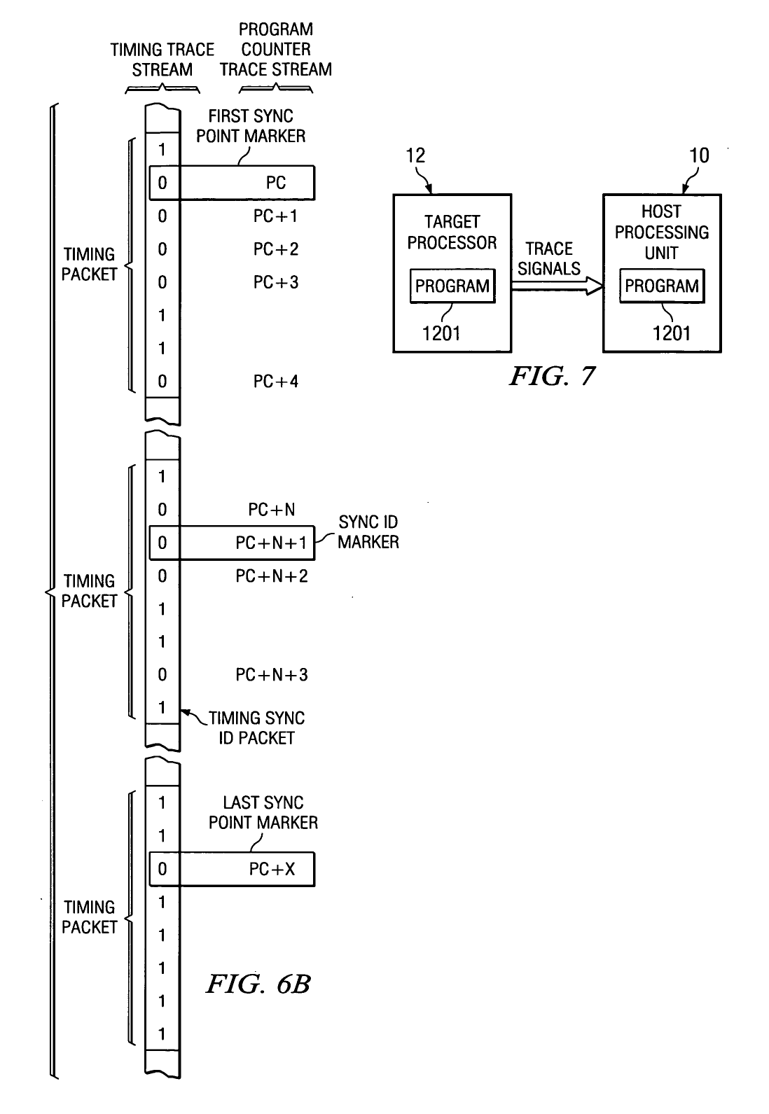

Referring to FIG. 6A, a program counter trace stream for a hypothetical program execution is illustrated. In this program example, the execution proceeds without interruption from external events. The program counter trace stream will consist of a first sync point marker 601, a plurality of periodic sync point ID markers 602, and last sync point marker 603 designating the end of the test procedure. The principal parameters of each of the packets are a sync point type, a sync point ID, a timing index, and an absolute PC value. The first and last sync points identify the beginning and the end of the trace stream. The sync ID parameter is the value from the value from the most recent sync point ID generator unit. In the preferred embodiment, this value in a 3-bit logic sequence. The timing index identifies the status of the clock signals in a packet, i.e., the position in the 8 position timing packet when the event producing the sync signal occurs. And the absolute address of the program counter at the time that the event causing the sync packet is provided. Based on this information, the events in the target processor can be reconstructed by the host processor.

Referring to FIG. 6B, the reconstruction of the program execution from the timing and program counter trace streams is illustrated. The timing trace stream consists of packets of 8 logic “0”s and logic “1”s. The logic “0”s indicate that either the program counter or the pipeline is advanced, while the logic “1”s indicate the either the program counter or the pipeline is stalled during that clock cycle. Because each program counter trace packet has an absolute address parameter, a sync ID, and the timing index in addition to the packet identifying parameter, the program counter addresses can be identified with a particular clock cycle. Similarly, the periodic sync points can be specifically identified with a clock cycle in the timing trace stream. In this illustration, the timing trace stream and the sync ID generating unit are in operation when the program counter trace stream is initiated. The periodic sync point is illustrative of the plurality of periodic sync points that would typically be available between the first and the last trace point, the periodic sync points permitting the synchronization of the three trace streams for a processing unit.

Referring to FIG. 7, the general technique for reconstruction of the trace streams is illustrated. The trace streams originate in the target processor 12 as the target processor 12 is executing a program 1201. The trace signals are applied to the host processing unit 10. The host processing unit 10 also includes the same program 1201. Therefore, in the illustrative example of FIG. 6 wherein the program execution proceeds without interruptions or changes, only the first and the final absolute addresses of the program counter are needed. Using the advance/non-advance signals of the timing trace stream, the host processing unit can reconstruct the program as a function of clock cycle. Therefore, without the sync ID packets, only the first and last sync markers are needed for the trace stream. This technique results in reduced information transfer. FIG. 6 includes the presence of periodic sync ID cycles, of which only one is shown. The periodic sync ID packets are important for synchronizing the plurality of trace streams, for selection of a particular portion of the program to analyze, and for restarting a program execution analysis for a situation wherein at least a portion of the data in the trace data stream is lost. The host processor can discard the (incomplete) trace data information between two sync ID packets and proceed with the analysis of the program outside of the sync timing packets defining the lost data.

In the preferred embodiment, the state machine operates in three states, a program execution state (also known as a primary or a background state), a interrupt service routine state (also known as a secondary or foreground state) and a halt or break state. In the program execution state, program instructions are executing in the central processing unit. In the interrupt service routine state, interrupt service routine instruction are executing on the central processing unit hardware. And in the halt or break state, the pipeline of the central processing unit is not execution instructions.

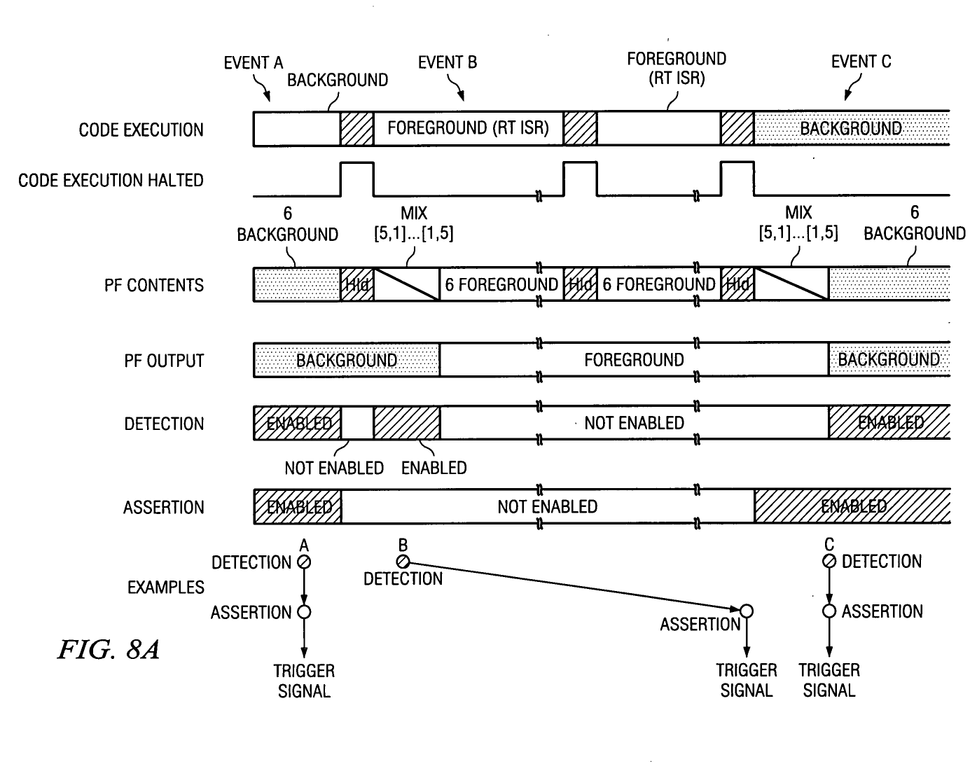

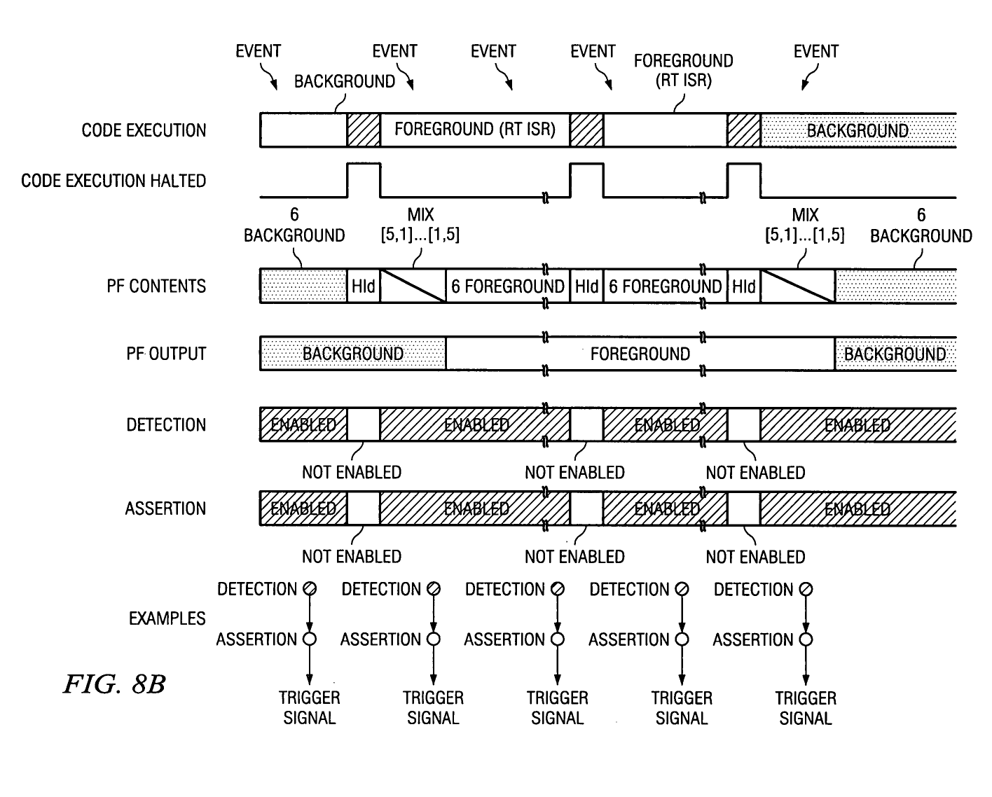

Referring to FIG. 8A, three events are indicated during the operation of the target processor with the condition that the presence of the event can not be asserted during foreground code execution. As will be clear, the indicated events can be combination of events detected by the test and debug apparatus of the target processor. Two of the events occur during the background (normal program) code execution. Because the assertions of the response to an event are not prohibited during the background code execution, the assertion of the response to the events, as exemplified by the generation of trigger signal, occur immediately. The middle illustrated event occurs during a foreground code execution. Because the assertion of the response to the event is prohibited from occurring during the foreground code execution, the results of the detection of the event are delayed until the target processor returns to the background code execution.

Referring to FIG. 8B, the response to an event that can occur either during background code execution or foreground code execution is illustrated. Several events are indicated in FIG. 8B. The response to the events, as exemplified by the generation of trigger signals, is performed without delay. The generation of a trigger signal results in an appropriate response by the target processor.

2. Operation of the Preferred Embodiment

Using the apparatus of the present invention, the assertion (response) to detection of an event can be controlled. As illustrated in FIG. 8A for a protected pipeline, when the assertion of an event is prohibited from occurring during a secondary (interrupt service procedure) code execution, then the assertion of the response is delayed until the background code execution is in progress. In the preferred embodiment, the trigger unit is used to provide the control of the assertion of the response to an event. The trigger unit can be programmed by the user to determine the response to an event. The trigger unit has applied thereto control signals from the central processing unit, control signals that can indicate the code execution mode of the target processor. Therefore, the trigger unit has the apparatus to detect and to control the response to input signals.

The foregoing discussion relates to a protected pipeline and a pipeline flattener. The pipeline flattener is device that takes the instructions from a pipeline and provides a delay so that the instruction can be aligned with memory accesses. Similar examples of selectable responses to an event can be provided for a protected pipeline and with and without the pipeline flattener.

The sync marker trace steams illustrated above relate to an idealized operation of the target processor in order to emphasize the features of the present invention. In particular, the event, resulting in the generation of trigger signal, typically involves the generation of a sync signal group in program counter trace stream.

In the foregoing discussion, the sync markers can have additional information embedded therein depending on the implementation of the apparatus generating and interpreting the trace streams. This information will be related to the parameters shown in FIG. 5. It will also be clear that a data trace stream, as shown in FIG. 2 will typically be present. The periodic sync IDs as well as the timing indexes will also be included in the data trace stream. In addition, the program counter absolute address parameter can be replaced by the program counter off-set register in certain situations.

While the invention has been described with respect to the embodiments set forth above, the invention is not necessarily limited to these embodiments. Accordingly, other embodiments, variations, and improvements not described herein are not necessarily excluded from the scope of the invention, the scope of the invention being defined by the following claims.

What is claimed is:

1. In a target processor, an apparatus for controlling the response to an event, the apparatus comprising:
a central processing unit;
first signal paths from selected apparatus in the central processing unit, the selected apparatus receiving predetermined event signals;
second signal paths from target processor mode identifying the mode of operation a central of the of operation signals
a unit coupled to the first and second signal paths, the unit providing a response to event signals the signals on the second signal paths.

2. The apparatus as recited in claim 1 wherein the unit receives control signals from a user.

3. The apparatus as recited in claim 1 wherein the response to an event signal detected during a first mode of instruction code execution is delayed until a second mode of instruction code execution.

4. The apparatus as recited in claim 3 wherein the first mode of instruction code execution a background mode of instruction execution and a second mode of instruction execution was a foreground or program mode of instruction execution.

5. The apparatus as recited in claim 1 wherein the unit is a trigger unit and wherein the response to an event signal is the generation of a trigger signal.

6. The apparatus as recited in claim 5 further comprising trace stream generation apparatus, wherein the trigger unit generates a sync signal in response to a trigger signal.

7. The method of responding to an event detected in a target processor, the method comprising:
providing an immediate response to an event detected during a first mode of instruction execution; and
providing a delayed response to an event detected during a second mode of instruction execution, the response to the event delayed until the target processor enters a second mode of instruction execution.

8. The method as recited in claim 7 wherein the first mode of instruction execution is a background or program code execution mode and the second mode of instruction execution is a foreground ground or interrupt service routine program code execution mode.

9. The method as recited in claim 8 further comprising:
in response to first control signals, providing an immediate response to an event during the first and the second mode of code execution.

10. The method as recited in claim 7 wherein the immediate and the delayed response is the generation of a trigger signal.

11. A test and debug system in a target processor, the system comprising:
a central processing unit, the central processing unit generating event signals and mode of operation signals; and
a logic unit responsive to the event signals and to the mode of operation signals, the logic unit providing an immediate response to an event signal in a first mode of operation, the logic unit providing a response to an event signal during second mode of operation in the first mode of operation.

12. The system as recited in claim 11 wherein the first mode of operation is a background or program mode of instruction execution and the second mode of operation is a background or interrupt service routine mode of instruction execution.

13. The system as recited in claim 11 wherein the response is a generation of trigger signal.

14. The system as recited in claim 11 wherein, in response to first control signals, the response of the logic unit to an event is generated immediately in both the first and the second mode of operation.

15. The system as recited in claim 14 further comprising trace stream generating apparatus, the response of the logic unit is the generation of a trigger signal, the trigger signal resulting in a sync marker in the trace stream.
